(19) United States
(12) Patent Application Publication
(10) Pub. No.: US 2026/0282071 A1
(43) Pub. Date: Sep. 17, 2026

(54) LOGICAL CHANNEL PRIORITIZATION MECHANISM

(71) Applicant: Apple Inc., Cupertino, CA (US)

(72) Inventors: Fangli Xu, Beijing (CN); Haijing Hu, Los Gatos, CA (US); Ralf Rossbach, Munich (DE); Ping-Heng Kuo, London (GB)

(73) Assignee: Apple Inc., Cupertino, CA (US)

(21) Appl. No.: 19/165,069

(22) PCT Filed: Mar. 31, 2023
(86) PCT No.: PCT/CN2023/085578

§ 371 Date: Sep. 12, 2025

(51) Int. Cl. H04W 72/563; H04W 72/1268; H04W 76/20; H04W 80/02

(52) U.S. Cl. CPC H04W 72/563; H04W 72/1268; H04W 76/20; H04W 80/02

(57) ABSTRACT

The present application relates to devices and components, including apparatus, systems, and methods for performing logical channel prioritization (LCP) procedures based on the dynamic information of the logical channels (LCHs).

### TECHNICAL FIELD

This application generally relates to cellular communication networks and, in particular, to technologies for logical channel prioritization.

### BACKGROUND

Extended reality (XR) is a workload that a cellular wireless network may support. It is desired to improve the capacity of the XR-specific traffic by more efficient resource allocation and to improve the quality of service by applying a more refined quality of service control.

### BRIEF DESCRIPTION OF THE DRAWINGS

FIG. 1 illustrates a network environment in accordance with some embodiments.

FIG. 2 illustrates an operational flow/algorithmic structure in accordance with some embodiments.

FIG. 3 illustrates an operational flow/algorithmic structure in accordance with some embodiments.

FIG. 4 illustrates an operational flow/algorithmic structure in accordance with some embodiments.

FIG. 5 illustrates an operational flow/algorithmic structure in accordance with some embodiments.

FIG. 6 illustrates an operational flow/algorithmic structure in accordance with some embodiments.

FIG. 7 illustrates an operational flow/algorithmic structure in accordance with some embodiments.

FIG. 8 illustrates an operational flow/algorithmic structure in accordance with some embodiments.

FIG. 9 illustrates a user equipment in accordance with some embodiments.

FIG. 10 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments.

However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; central processing unit (CPU); graphics processing unit; single-core processor; dual-core processor; triple-core processor; quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

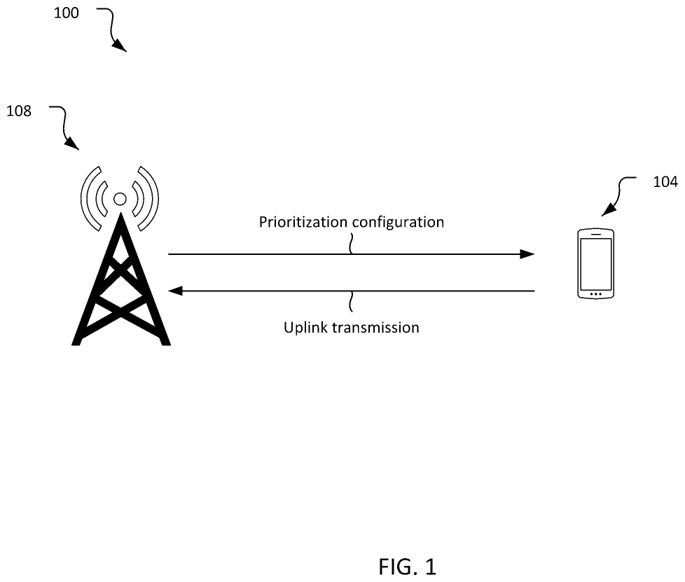

FIG. 1 illustrates a network environment 100 in accordance with some embodiments. The network environment 100 may include a UE 104 coupled with a base station (BS) 108 of a radio access network (RAN). In some embodiments, the BS 108 is a next-generation node B (gNB) that provides one or more 3GPP New Radio (NR) cells. In other embodiments, the BS 108 is an evolved node B (eNB) that provides one or more Long Term Evolution (LTE) cells. The air interface over which the UE 104 and the BS 108 communicate may be compatible with 3GPP technical specifications (TSs), such as those that define Fifth Generation (5G) NR or later system standards (e.g., Sixth Generation (6G) standards).

The network may provide XR or multimedia (XRM) services to the UE. In an XRM service, the information generated by the application may be represented by a packet data unit (PDU) set in a PDU session. A PDU set is made of one or more PDUs carrying the payload of one unit of information generated at the application layer. For example, a frame, e.g., an I-Frame, B-Frame, or P-Frame, or a video slice for XRM services may form one PDU set. In some instances, the application layer requires all PDUs in a PDU set to retrieve the corresponding unit of information. In some cases, the application layer may recover parts of the information unit even when some PDUs are missing. A PDU in a PDU set of an XRM service may contain packets with different delay requirements, levels of importance, or, in general, different quality of service (QOS) requirements. In some instances, the QoS is applied to a PDU set as a whole, e.g., the QoS parameters maintenance, retransmission, and QoS scheduling in MAC are applied uniformly to all packets in the PDUs and all PDUs in a PDU set.

In Layer 2 (L2), the application data is assigned to one or more logical channels (LCH). The L2 may include a medium access (MAC) layer, which is a sublayer of L2 in 3GPP cellular architecture. Packets with different QoS requirements may be transmitted via the same LCH. For example, the XRM traffic may include packets with different QoS requirements that are served with the same LCH.

In one instance, the legacy LTE network assigns priority to each LCH via dedicated radio resource control (RRC) signaling. At uplink (UL) transmission, the UE scheduler selects a group of LCH based on their configurations and priorities set by the RRC signaling and performs a bucket token algorithm. In the bucket token algorithm, each LCH has its own priority bit rate (PBR), B. For example, the PBR of LCH_1 may be B_1, and the PBR of LCH_2 may be B_2, and so on. The UE scheduler allocates B_i bits to the LCH_i, starting with the LCH having the highest priority and moving down the selected LCH list in decreasing priority order.

The traffic characteristics of 5G and later technologies may be more dynamic and include packets with different QoS requirements. For example, the XRM packet QoS requirements, e.g., delay requirement or urgent level of each packet, may vary rapidly and dynamically. Changing the priority of LCH via legacy RRC signaling may not be sufficient to meet the dynamic needs of 5G traffic. It is desired to make the LCH selection and allocate resources to each selected LCH dynamically and based on the current LCH status of the LCH, e.g., the LCH's data buffer status.

The network scheduler at the BS 108 may schedule uplink transmission at the UE 104. The UE 104 may report the delay and buffer status report (BSR) to the BS 108 to facilitate the UL scheduling. For example, the UE 104 may use a buffer status report (BSR) to send information to the BS 108 about the data ready to be transmitted at the UE. The network scheduler at the BS 108 may use the UE-reported delay information and BSI for UL scheduling, e.g., the information conveyed by the BSR. For example, the BS 108 may schedule the urgent packets or data sooner than packets with more flexible delay requirements. The BS 108 may send a prioritization configuration via L1 or L2 signaling (L1/L2 signaling) to dynamically adjust the LCH priorities and LCP procedure to meet the QoS requirement of the UL traffic. The UE performs the LCP procedure and selects the LCH and packet to assemble the MAC PDU based on the dynamic L1/L2 signaling.

In one embodiment, the BS 108 may use dynamic LCP configuration activation at the UE 104. The BS 108 configures the UE 104 with a set, including multiple LCP configurations for a given LCH. An index may identify each LCP configuration in the set. The BS 108 may send an L1/L2 command and activate one LCP configuration per LCH. For example, the L1/L2 command may include an index to identify the LCH and another index to indicate the activated LCP configuration associated with that LCH.

The BS 108 may send the L1 command using the UL grant. In one instance, a few LCHs, e.g., only one or two LCHs, may be activated via a UL grant. The BS 108 may send the L2 command using the MAC CE. In one instance, the MAC CE may activate one LCP configuration from the set of LCPs configured by RRC. In another instance, the MAC CE may explicitly provide the LCH's LCP configuration, e.g., set the LCH's priority.

When performing the LCP procedure, the UE 104 may apply the LCP configuration for each LCH. If the L1/L2 command explicitly activated an LCP configuration for an LCH, the UE 104 may apply the activated configuration. In one example, the UE 104 may disregard any previous LCP configuration, e.g., RRC configuration, and apply and use the explicit configuration based on the L1/L2 command. However, if an LCH is not explicitly configured with an LCP in an L1/L2 command, the UE 104 may select a default LCP configuration, e.g., the LCP configuration with the highest or lowest index.

In one example embodiment, the BS 108 configures LCH_1 of the UE 104 with two priorities, X and Y, using RRC signaling. The LCH_1 priority X has an index with a value of 1, and LCH_1 priority Y has an index with a value of 2. The BS 108 sends an L2 command via MAC CE to the UE 104 to activate LCH_1 with a priority index equal to 2. The BS 108 may send an UL grant to the UE 104 to schedule uplink transmission. The UE 104 performs the LCP procedure based on LCH_1 having priority Y.

In one example embodiment, the BS 108 configures LCH_1 of the UE 104 with priority X using RRC signaling. The BS 108 sends an L2 command via MAC CE to the UE 104 to activate LCH_1 with a priority Y. The BS 108 may send an UL grant to the UE 104 to schedule uplink transmission. The UE 104 performs the LCP procedure based on LCH_1 having priority Y.

In one example embodiment, the BS 108 configures LCH_1 of the UE 104 with two priorities, X and Y, using RRC signaling. The LCH_1 priority X has an index with a value of 1, and LCH_1 priority Y has an index with a value of 2. The BS 108 may send an UL grant to the UE 104 to schedule uplink transmission. The UL grant may activate the LCH_1 with a priority index equal to 2. The UE 104 performs the LCP procedure based on LCH_1 having priority Y.

In one example embodiment, the BS 108 configures LCH_1 of the UE 104 with two priorities, X and Y, using RRC signaling. The LCH_1 priority X has an index with a value of 1, and LCH_1 priority Y has an index with a value of 2. Further, the BS 108 may configure the LCH_1 of the UE 104 with default priority index 1. The BS 108 may send an UL grant to the UE 104 to schedule uplink transmission. The UL grant does not contain any activation command for LCH_1. The UE 104 performs the LCP procedure based on LCH_1 having priority X (default priority).

The LCP configuration of an LCH may include different parameters. For example, the LCP configuration may include a priority associated with the LCH, a PBR, or a bucket size (referred to as Bj in 3GPP specifications) of the bucket token algorithm. In one instance, the RRC configures the LCH with a set of LCP configurations. Each LCP configuration in the set may be a complete configuration including all the parameters, e.g., priority, PBR, or bucket size. In another instance, the RRC configures the LCH with a set of LCP configurations in which each LCP configuration includes a subset of the parameters, e.g., only priorities.

In one embodiment, the network, e.g., the BS 108, may provide an LCP configuration for an LCH where the LCP includes an urgent flag. For example, the BS 108 may configure the UE 104 via RRC signaling, including LCP configuration of an LCH with an urgent flag. The urgent flag may act similarly to the priority level of the LCH. In one instance, the urgent flag may indicate whether the LCH has data that requires to be transmitted immediately. In another example, the urgent flag may take several values or levels, each value or level to indicate the urgency of the LCH to be scheduled. For example, urgent level 0 may indicate no urgency (a non-urgent LCH), and an urgent level 2 may indicate a higher urgency than an urgent level 1. An LCH with an activated urgent flag, or an urgent level different than a value associated with no urgency, may be referred to as an urgent LCH.

The BS 108 may also configure the UE 104 with an urgent LCP configuration via RRC signaling. The urgent LCP configuration may configure all LCP parameters, e.g., LCH priority, PBR, or Bj, or a subset of the LCP parameters, e.g., priority.

In one example, the BS 108 may activate the urgent LCP procedure via an L1/L2 signaling. The urgent LCP procedure may select only LCHs with a configured urgent flag. The urgent LCP procedure may select LCHs with or without configured urgent flags. However, the LCP procedure may prioritize the LCHs with an urgent flag to assemble the MAC PDU.

In one instance, the BS 108 may indicate the urgent level in an L1/L2 signaling. An LCH with an active urgent flag may activate or enable the urgent LCP procedure. For example, the BS 108 may indicate the urgent level in the scheduled UL grant. In another instance, the UE may, based on its local information or condition, decide to enable the urgent LCP procedure. The UE 104 may enable the urgent LCP procedure based on the buffer status parameters of an LCH. For example, the UE 104 may compare the delay of packets (e.g., average delay) in an LCH and compare it to a threshold and activate the urgent LCP procedure, sets the urgent level of the LCH, or activate the urgent flag of the LCH, when the delay of packets is larger than the threshold.

In an urgent LCP procedure, the UE 104 may apply urgent LCP configuration or prioritize the urgent LCH. In one embodiment, the UE 104 may only include the urgent LCHs in the LCP procedure and uses the urgent LCHs data to assemble the MAC PDU. In another embodiment, the UE 104 may decide the allowed LCH set according to an LCH mapping restriction and prioritize the selected LCHs based on their urgent flag during the LCP procedure. In another embodiment, the UE may determine the allowed LCH set (set of LCHs considered by the LCP procedure) according to the LCH mapping restriction and apply the urgent LCP configuration for the LCH if provided. The LCH mapping restriction may be based on the legacy implementation, e.g., the LCH mapping restriction as defined in the 3GPP specification for LTE. While the legacy LCH mapping restriction provides the set of LCH, the updated LCH priority provided by the urgent flag and dynamic L1/L2 signaling enables dynamic adjustment of the legacy LCP procedure.

For example, consider the UE 104 having three LCHs, LCH_1, LCH_2, and LCH_3. The BS 108 may configure LCH_1 and LCH_2 with urgent indications or urgent flags and LCH_3 without an urgent indication or flag. The BS 108 enables urgent LCP procedure, or the UE 104 enables the urgent LCP procedure based on local conditions. In one example, the UE 104 only consider LCH_1 and LCH_2 in urgent LCP based on their configured urgent flag. In another example, the UE 104 may consider LCH_1, LCH_2, and LCH_3 in the LCP procedure but prioritize LCH_1 and LCH_2 over LCH_3 based on their configured urgent flag.

In another example, consider the UE 104 having three LCHs, LCH_1, LCH_2, and LCH_3. The LCH_1 and LCH_2 are configured with urgent LCP configurations, and LCH_3 is not configured with urgent LCP configurations. For example, the BS 108 may configure LCH_1 and LCH_2 with urgent LCP configurations via RRC signaling. The BS 108 or the UE 104 (e.g., based on detecting a condition at the UE 104) may enable urgent LCP procedures. In one instance, the LCP procedure may only select LCH_1 and LCH_2, based on their urgent LCP configuration, to assemble the MAC PDU. In another instance, the LCP procedure may select LCH_1, LCH_2, and LCH_3 based on the legacy LCH mapping restriction and apply urgent LCP configuration to LCH_1 and LCH_2. As mentioned above, the LCP configuration may configure the priority of the LCH as well as other parameters, such as PBR or bucket token parameter, Bj, associated with the LCH.

In one embodiment, the BS 108 may explicitly indicate the allowed LCH set. The allowed LCH set is the set of LCHs included during the LCP procedure to assemble the MAC PDU. In one instance, the BS 108 may indicate the allowed LCH set in L1/L2 command. For example, the Bs 108 may indicate the allowed LCH set in the UL grant, e.g., dynamic grant (DG).

In one instance, the BS 108 may indicate the allowed LCH set in L3 signaling. For example, the BS 108 may indicate the allowed LCH set in RRC configuration, e.g., configured grant (CG) for UL transmission. The BS 108 may send an L1 command, e.g., a downlink control information (DCI), to activate or deactivate the CG. The UE 104 may apply the indicated LCH set for all activated CG occasions. Alternatively, the UE 104 may apply the indicated LCH set during the LCP procedure for a subset of CG occasions. The subset of the CG occasions may be configured by the BS 108 or based on a predefined rule, e.g., applying the indicated LCH set to the LCP procedure on the first CG occasion or the first K CG occasions.

In another embodiment, the BS 108 may explicitly indicate a prohibited (e.g., non-allowed or restricted) LCH set. A prohibited LCH set is a set of LCHs excluded during the LCP procedure from assembling the MAC PDU. In one instance, the BS 108 may indicate the allowed LCH set in L1/L2 command. For example, the BS 108 may indicate the prohibited LCH set in the UL grant, e.g., dynamic grant (DG). The UE 104 may not include the LCHs in the prohibited set during the LCP procedure.

In one instance, the BS 108 may indicate the prohibited LCH set in L3 signaling. For example, the BS 108 may indicate the prohibited LCH set in RRC configuration, e.g., configured grant (CG) for UL transmission. The BS 108 may send an L1 command, e.g., a downlink control information (DCI), to activate or deactivate the CG. The UE 104 may apply the indicated LCH set for all activated CG occasions. Alternatively, the UE 104 may apply the indicated LCH set during the LCP procedure for a subset of CG occasions. The subset of the CG occasions may be configured by the BS 108 or based on a predefined rule, e.g., applying the indicated LCH set to the LCP procedure on the first CG occasion or the first K CG occasions.

In one embodiment, the UE 104 may select the LCHs that are considered and participated during the LCP procedure based on the delay characteristics of the packets buffered in the LCHs. The BS 108 may provide a delay threshold via L1/L2/L3 signaling. The same delay threshold may apply to all LCHs, or the LCHs may be partitioned into subsets, and each subset is assigned a threshold. For example, an LCH may be associated with a threshold that may be different than the threshold associated with a different LCH.

The UE 104 may compute a delay associated with each LCH. The delay may be based on the waiting time of the data in the buffer associated with the LCH. In one instance, the UE 104 may only select an LCH if the calculated delay for that LCH is greater than or equal to the threshold. The selected LCHs are included in the LCP procedure. If no LCH meets the delay condition, the UE 104 may follow the legacy or default LCP procedure. In some instances, the UE 104 may prioritize the LCH with a calculated delay greater than or equal to the threshold and apply the priority to the legacy or default LCP procedure. The LCH priority may be based on the value of the computed delay or the difference between the computed delay and the threshold. Alternatively, the LCH priority may follow the configured priorities for the LCHs.

The delay threshold may be an absolute value. The delay threshold may be a relative value. A relative value may be a fraction of the packet delay budget (PDB) associated with the QoS flows mapped to the LCH.

During the LCP procedure, the data from a participating LCH is selected and included in the MAC PDU. The UE 104 may include the data from LCH in the MAC PDU, which meet the delay condition. For example, the UE 104 may include the data from an LCH when the delay associated with the data is greater than or equal to the threshold. For each selected LCH, the UE 104 may select the packets that meet the delay condition regardless of the bucket token algorithm. After selecting the packets meeting the delay condition, the remaining capacity of the MAC PDU, if any, may be filled according to the legacy mechanism. The UE 104 may limit the number of bits or bytes of data selected from each LCH, e.g., based on the legacy mechanism, e.g., the PBR or the token bucket parameter, Bj, associated with the LCH.

In legacy implementation, MAC CE may have a higher priority than data. In one embodiment, the BS 108 may explicitly indicate, via L1/L2/L3 message, to deprioritize the MAC CE transmission in a dynamic or configured grant. The UE 104 prioritize the data transmission compared to the MAC CE during the LCP procedure for the indicated UL grant. The L1 message may be a DCI signaling, the L2 message may be a MAC CE, and the L3 message may be an RRC signaling. The deprioritization may only apply if there is data to be transmitted. If additional capacity in the MAC PDU is available after assembling MAC PDU with data, the UE 104 may consider MAC CE for filling all or part of the remaining capacity.

In one embodiment, an LCH may be in one of at least two states based on the network configuration. The UE 104 may determine the state of the LCH based on the status of buffered data associated with the LCH. For example, the LCH is in a first state if the delay of the buffered data is lower than a threshold, and the LCH is in a second state if the delay of the buffered data is higher than a threshold. In another example, the LCH is in a first state if the volume of the buffered data is lower than the threshold, and the LCH is in a second state if the volume of the buffered data is higher than the threshold.

The BS 108 may configure each LCH individually with a condition. The UE 104 uses the condition to determine or switch the LCH state. For example, the condition may be a delay or data volume threshold. The BS 108 may allocate uplink resources only to LCHs in a particular state.

The BS 108 may determine the state of an LCH and configures the UE 104 with the state of that LCH. For example, the BS 108 may send a 1-bit flag in a dynamic grant DCI to determine the state of an LCH. The BS 108 may use a parameter in the configured grant information element of the corresponding RRC signaling to set the state of an LCH.

The BS 108 may allocate uplink resources and prioritize LCHs in a particular state to use those resources. The BS 108 may use a 1-bit flag in an L1/L2/L3 command to limit the resources to LCHs in a particular state or to prioritize LCHs in a particular state. When the BS 108 allocates uplink resources and restricts them to be used by LCHs in a particular state, the UE 104 may select the LCHs that are in the state associated with the resources and generate the MAC PDU using the selected LCHs. When the BS 108 allocates uplink resources and prioritizes LCHs in a particular state to use them, the UE 104 may prioritize the LCHs that are in the state associated with the resource. If there were spare resources within the grant after allocating resources to the prioritized LCHs, the UE 104 may multiplex the data from the LCHs that are not in the state associated with the resources.

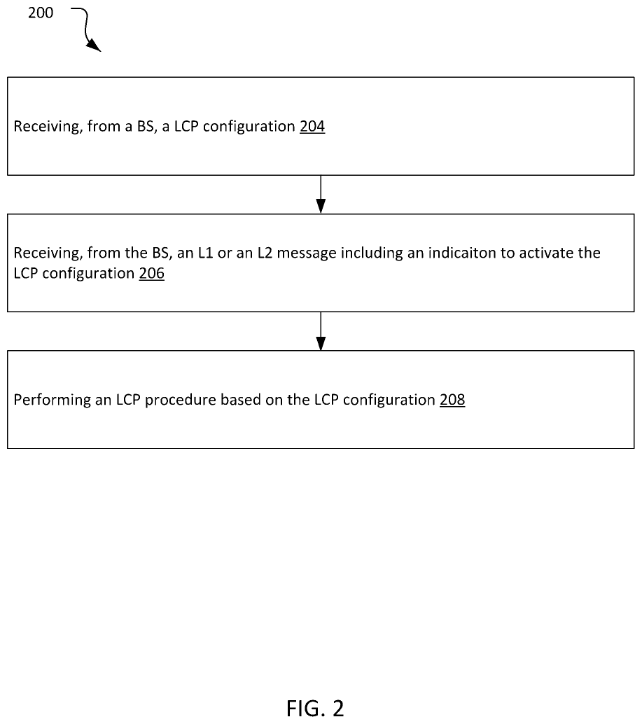

FIG. 2 illustrates an operational flow/algorithmic structure 200 in accordance with some embodiments. Operational flow/algorithmic structure 200 is an example of operating a UE to provide dynamic LCH prioritization for LCP procedure. The operational flow/algorithmic structure 200 may be implemented by a UE, for example, the UE 104, the UE 900, or components therein, e.g., processors 904.

The operational flow/algorithmic structure 200 may include, at 204, receiving an LCP configuration from a BS. The LCP configuration may be included in an L1/L2/L3 message. The LCP configuration may be a set of priorities or a set of LCP configurations associated with an LCH. The LCP configuration may include an urgent flag associated with the LCH.

The operational flow/algorithmic structure 200 may include, at 206, receiving an L1/L2 message from the BS, where the message includes an indication to activate the LCP configuration. The L1 message may be a DCI carrying a dynamic UL grant. The L2 message may be a MAC CE.

The operational flow/algorithmic structure 200 may include, at 208, performing an LCP procedure based on the LCP configuration. The LCP procedure may be a configured urgent LCP procedure.

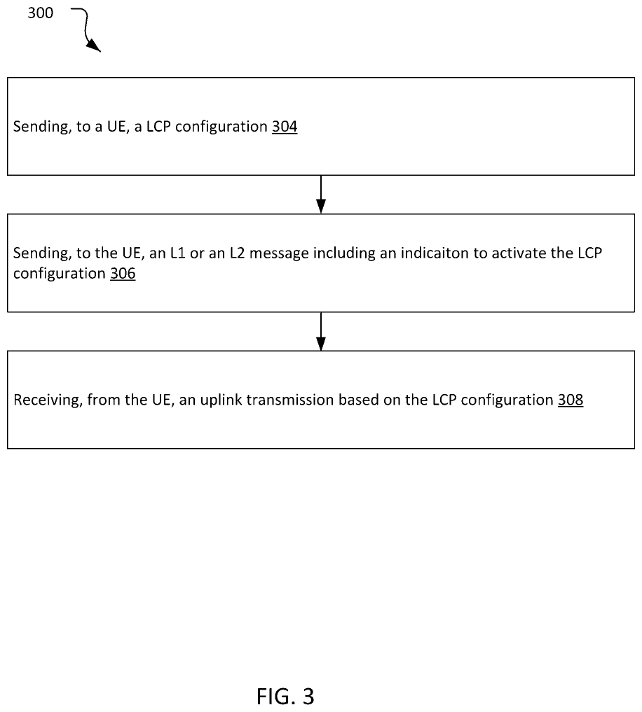

FIG. 3 illustrates an operational flow/algorithmic 300 structure in accordance with some embodiments. Operational flow/algorithmic structure 300 is an example of operating a BS to provide dynamic LCH prioritization for the LCP procedure. The operational flow/algorithmic structure 300 may be implemented by a BS, for example, the BS 108, the BS 1000, or components therein, e.g., processors 1004.

The operational flow/algorithmic structure 300 may include, at 304, sending an LCP configuration to a UE. The LCP configuration may be included in an L1/L2/L3 message. The LCP configuration may be a set of priorities or a set of LCP configurations associated with an LCH. The LCP configuration may include an urgent flag associated with the LCH.

The operational flow/algorithmic structure 300 may include, at 306, sending an L1/L2 message to the UE, where the message includes an indication to activate the LCP configuration. The L1 message may be a DCI carrying a dynamic UL grant. The L2 message may be a MAC CE.

The operational flow/algorithmic structure 300 may include, at 308, receiving an uplink transmission from the UE based on the LCP configuration. The UE may use the LCP configuration to assemble the MAC PDU.

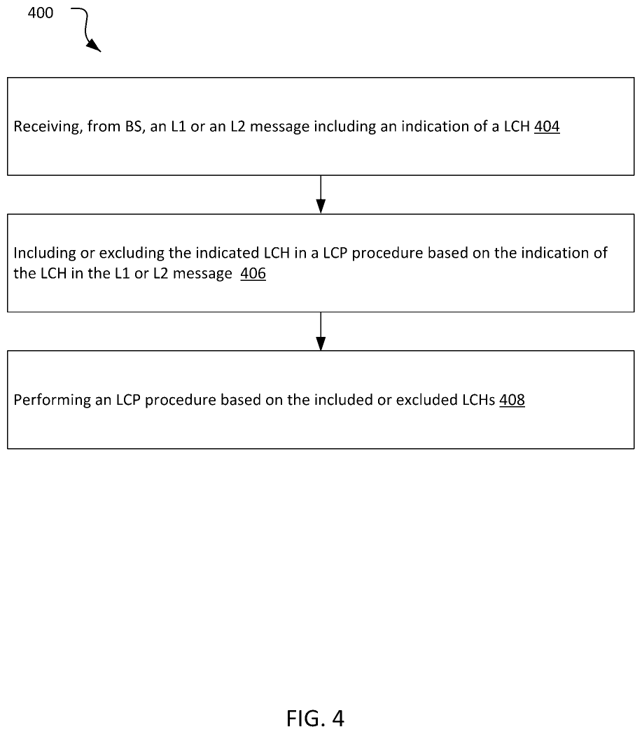

FIG. 4 illustrates an operational flow/algorithmic structure 400 in accordance with some embodiments. Operational flow/algorithmic structure 400 is an example of operating a UE to provide dynamic LCH prioritization for LCP procedure. The operational flow/algorithmic structure 400 may be implemented by a UE, for example, the UE 104, the UE 900, or components therein, e.g., processors 904.

The operational flow/algorithmic structure 400 may include, at 404, receiving an L1/L2 message from a BS where the message includes an indication of an LCH. The L1 message may be a UL grant included in a DCI. The L2 message may be a configured grant (CG), including an active CG occasion.

The operational flow/algorithmic structure 400 may include, at 406, including or excluding the indicated LCH in an LCP procedure based on the indication of the LCH in the L1/L2 message.

The operational flow/algorithmic structure 400 may include, at 408, performing an LCP procedure based on the included or excluded LCHs.

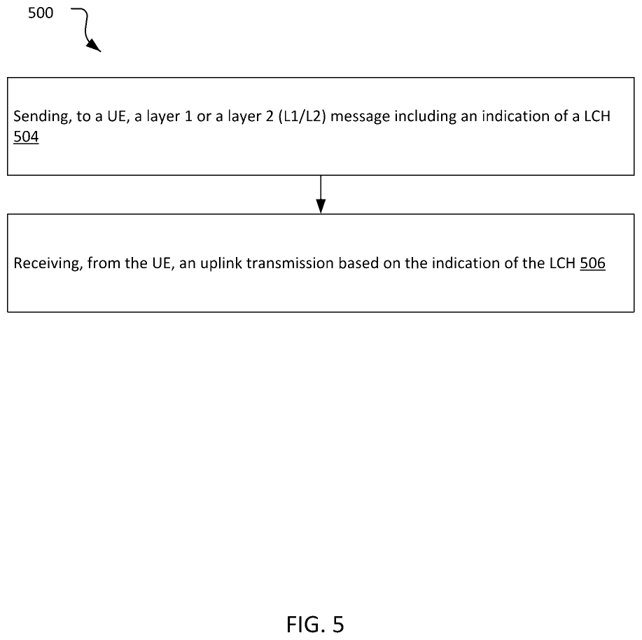

FIG. 5 illustrates an operational flow/algorithmic structure 500 in accordance with some embodiments. Operational flow/algorithmic structure 500 is an example of operating a BS to provide dynamic LCH prioritization for the LCP procedure. The operational flow/algorithmic structure 500 may be implemented by a BS, for example, the BS 108, the BS 1000, or components therein, e.g., processors 1004.

The operational flow/algorithmic structure 500 may include, at 504, sending an L1/L2 message to a UE where the message includes an indication of an LCH. The L1/L2 message indicates to the UE to include or exclude the indicated LCH in an LCP procedure. The L1 message may be a UL grant included in a DCI. The L2 message may be a configured grant (CG), including an active CG occasion.

The operational flow/algorithmic structure 500 may include, at 506, receiving an uplink transmission from the UE based on the inclusion or exclusion of the LCH. The UE may apply the inclusion or exclusion of LCHs in the LCP procedure to assemble the MAC PDU and sends the MAC PDU to the BS.

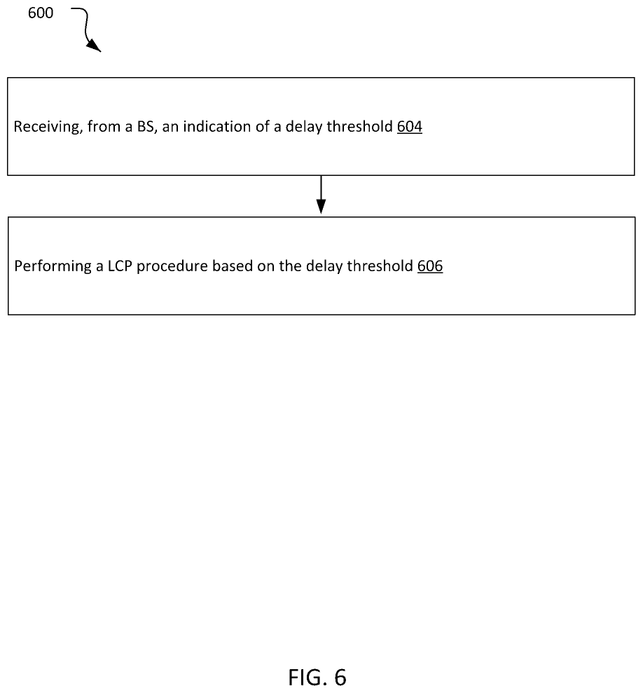

FIG. 6 illustrates an operational flow/algorithmic structure 600 in accordance with some embodiments. Operational flow/algorithmic structure 600 is an example of operating a UE to provide dynamic LCH prioritization for LCP procedure. The operational flow/algorithmic structure 600 may be implemented by a UE, for example, the UE 104, the UE 900, or components therein, e.g., processors 904.

The operational flow/algorithmic structure 600 may include, at 604, receiving an indication of a delay threshold from a BS.

The operational flow/algorithmic structure 600 may include, at 606, performing a LCP procedure based on the delay threshold. The UE may compute a delay associated with an LCH and compare the computed delay of the LCH with the delay threshold. The UE may set the priority of the LCH based on the comparison. Increasing the priority of an LCH may be referred to as prioritizing that LCH. When an LCH is prioritized, the UE may increase the priority of that LCH, set the priority of that LCH higher than the priority of some LCHs, or set the priority of that LCH to be the highest priority. For example, if the delay of the LCH is greater than or equal to the threshold, the UE may increase the priority of the LCH. In one example, the UE may set the priority or the LCH to be the highest priority. The UE may select the logical channels with a delay greater than or equal to the delay threshold and prioritize the LCH based on a configured LCH priority. For example, if multiple LCHs meet the delay condition, e.g., having a delay greater than or equal to the threshold, the order for LCH selection amongst these LCHs follows the configured LCH priority. The configured LCH priority may assign a priority to the LCH based on the delay associated with the LCH or may set the priority of the LCH to a preconfigured level.

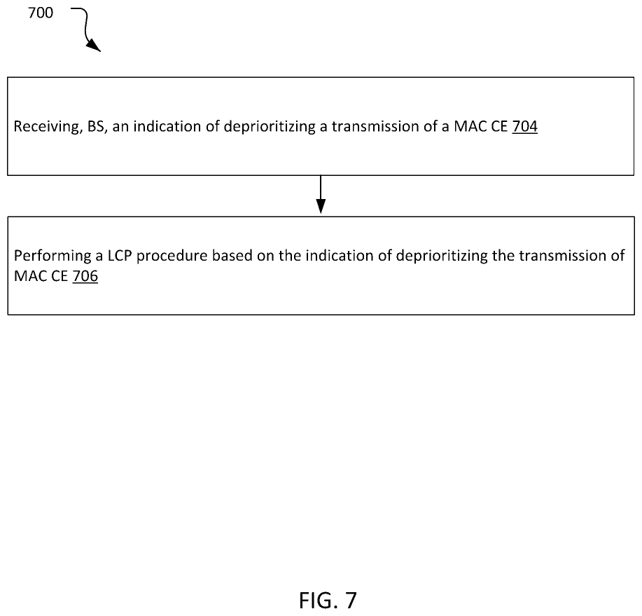

FIG. 7 illustrates an operational flow/algorithmic structure 700 in accordance with some embodiments. Operational flow/algorithmic structure 700 is an example of operating a UE to provide dynamic LCH prioritization for LCP procedure. The operational flow/algorithmic structure 700 may be implemented by a UE, for example, the UE 104, the UE 900, or components therein, e.g., processors 904.

The operational flow/algorithmic structure 700 may include, at 704, receiving an indication from a BS to deprioritize a transmission of a MAC CE.

The operational flow/algorithmic structure 700 may include, at 706, performing a LCP procedure based on the indication of deprioritizing the transmission of MAC CE.

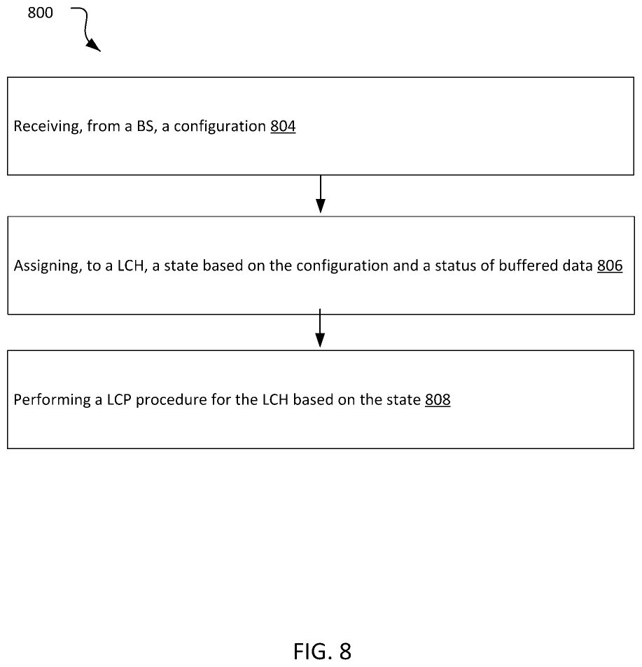

FIG. 8 illustrates an operational flow/algorithmic structure 800 in accordance with some embodiments. Operational flow/algorithmic structure 800 is an example of operating a UE to provide dynamic LCH prioritization for LCP procedure. The operational flow/algorithmic structure 800 may be implemented by a UE, for example, the UE 104, the UE 900, or components therein, e.g., processors 904.

The operational flow/algorithmic structure 800 may include, at 804, receiving a configuration from a BS. The configuration may be included in an RRC message, a MAC message, or a DCI.

The operational flow/algorithmic structure 800 may include, at 804, assigning a state to an LCH based on the configuration and a status of buffered data at the LCH.

The operational flow/algorithmic structure 800 may include, at 808, performing an LCP procedure for the LCH based on the state. The LCP procedure may include selecting an LCH based on the state associated with the LCH and prioritizing the LCH based on a configured LCH priority or the state associated with the LCH.

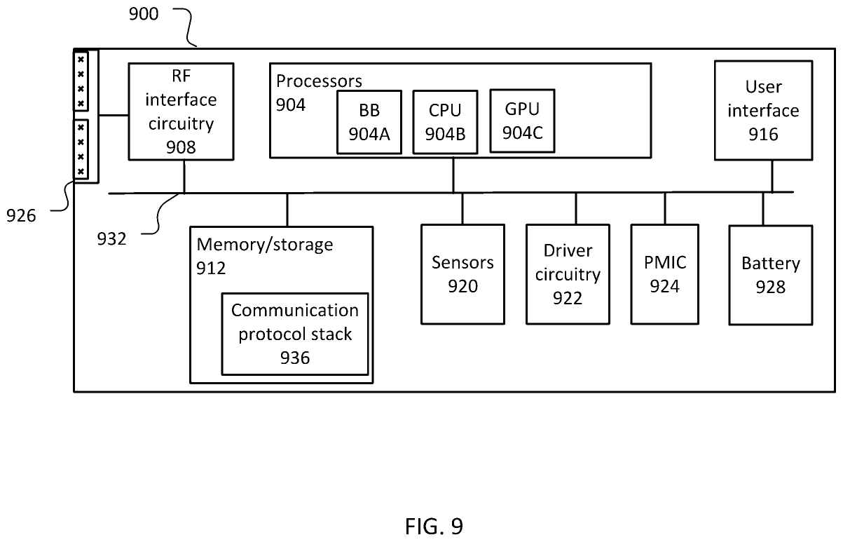

FIG. 9 illustrates a UE 900 in accordance with some embodiments. The UE 900 may be similar to and substantially interchangeable with UE 104 of FIG. 1.

The UE 900 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry, or processor circuitry that executes or otherwise operates computer-executable instructions, such as program code, software modules, or functional processes from memory/storage 912 to cause the UE 900 to perform operations as described herein.

The processors 904 may perform operations associated with performing LCP procedures based on the dynamic condition of the LCHs. For example, the processors 904 may receive configurations, indications or commands, identify LCHs based on the configurations, indications, or commands, assign LCP configurations or priorities, or perform LPC procedure based on the LCP configurations or priorities associated with LCHs consistent with embodiments described herein.

In some embodiments, the baseband processor circuitry 904A may access a communication protocol stack 936 in the memory/storage 912 to communicate over a 3GPP-compatible network. In general, the baseband processor circuitry 904A may access the communication protocol stack 936 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 908.

The baseband processor circuitry 904A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 912 may include one or more non-transitory, computer-readable media that includes instructions (for example, the communication protocol stack 936) that may be executed by one or more of the processors 904 to cause the UE 900 to perform various operations described herein. The memory/storage 912 includes any type of volatile or non-volatile memory that may be distributed throughout the UE 900. In some embodiments, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processor 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands, including bands in FR1 or FR2.

The user interface circuitry 916 includes various input/output (I/O) devices designed to enable user interaction with the UE 900. The user interface 916 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various I/O devices that may be present within or connected to the UE 900. For example, the driver circuitry 922 may include circuitry to facilitate the coupling of a universal integrated circuit card (UICC) or a universal subscriber identity module (USIM) to the UE 900. For additional examples, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage the power provided to various components of the UE 900. In particular, with respect to the processors 904, the PMIC 924 may control power-source selection, voltage scaling, battery charging, or DC-to-DC conversion.

In some embodiments, the PMIC 924 may control or otherwise be part of various power-saving mechanisms of the UE 900, including DRX, as discussed herein.

A battery 928 may power the UE 900, although in some examples, the UE 900 may be mounted and deployed in a fixed location and may have a power supply coupled to an electrical grid. The battery 928 may be a lithium-ion battery, a metal-air battery, such as a zinc-air battery, an aluminum-air battery, a lithium-air battery, and the like. In some implementations, such as in vehicle-based applications, the battery 928 may be a typical lead-acid automotive battery.

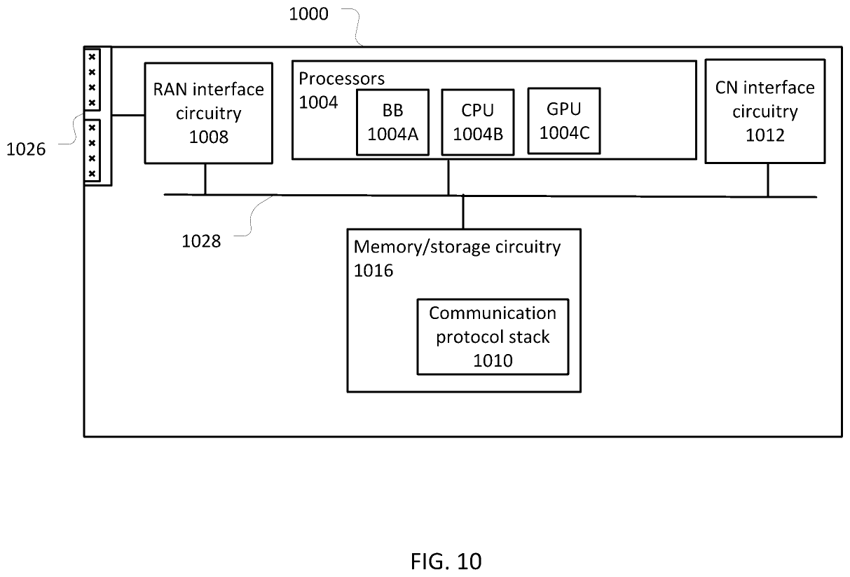

FIG. 10 illustrates a network node 1000 in accordance with some embodiments. The network node 1000 may be similar to and substantially interchangeable with base station 108, a device implementing one of the network hops, an integrated access and backhaul (IAB) node, a network-controlled repeater, or a server in a core network or external data network.

The network node 1000 may include processors 1004, RF interface circuitry 1008 (if implemented as an access node), the core node (CN) interface circuitry 1012, memory/storage circuitry 1016, and antenna structure 1026.

The components of the network node 1000 may be coupled with various other components over one or more interconnects 1028.

The processors 1004, RF interface circuitry 1008, memory/storage circuitry 1016 (including communication protocol stack 1010), antenna structure 1026, and interconnects 1028 may be similar to like-named elements shown and described with respect to FIG. 9.

The processors 1004 may perform operations associated with enabling a UE to modify the LCP procedure dynamically. For example, the processors 1004 may configure the UE to dynamically modify the LCP procedure and receive UL transmission from the UE based on UE configurations consistent with embodiments described herein.

The CN interface circuitry 1012 may provide connectivity to a core network, for example, a 5th Generation Core network (5GC) using a 5GC-compatible network interface protocol such as carrier Ethernet protocols or some other suitable protocol. Network connectivity may be provided to/from the network node 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some embodiments, the network node 1000 may be coupled with transmit-receive points (TRPs) using the antenna structure 1026, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method of operating a user equipment (UE), the method including: receiving, from a base station (BS), a logical channel prioritization (LCP) configuration; receiving, from the BS, a layer 1 (L1) or a layer 2 (L2) message including an indication to activate the LCP configuration; and performing an LCP procedure based on the LCP configuration.

Example 2 includes the method of example 1 or some other examples herein, wherein the LCP configuration is included in a radio resource control (RRC) message.

Example 3 includes the method of examples 1 or 2 or some other examples herein, wherein the LCP configuration is included in the L1 or L2 message.

Example 4 includes the method of any of examples 1-3 or some other examples herein, wherein said receiving an L1 or L2 message includes receiving an L1 message with a uplink grant or an L2 message with a medium access control (MAC) control element (CE).

Example 5 includes the method of any of examples 1-4 or some other examples herein, wherein the LCP configuration is associated with a logical channel (LCH) that includes an urgent flag.

Example 6 includes the method of any of examples 1-5 or some other examples herein, wherein the L1 or L2 message includes an urgent level associated with the urgent flag of the LCH.

Example 7 includes the method of any of examples 1-6 or some other examples herein, wherein the LCP procedure is an urgent LCP procedure based on the L1 or L2 message or based on a condition detected by the UE, the urgent LCP procedure includes: determining a set of LCHs based on the urgent flag or the LCP configuration; and prioritizing LCH based on the urgent flag or the LCP configuration.

Example 8 includes a method of operating a base station (BS), the method including: sending, to a user equipment (UE), a logical channel prioritization (LCP) configuration; sending, to the UE, a layer 1 (L1) or a layer 2 (L2) message including an 23 indication to activate the LCP configuration; and receiving, from the UE, an uplink transmission based on the LCP configuration.

Example 9 includes the method of example 8 or some other examples herein, wherein the LCP configuration is included in a radio resource control (RRC) message.

Example 10 includes the method of examples 8 or 9 or some other examples herein, wherein the indication to activate the LCP configuration is the LCP configuration.

Example 11 includes the method of any of examples 8-10 or some other examples herein, wherein said sending a L1 or L2 message comprises sending an L1 message with a uplink grant or an L2 message with a medium access control (MAC) control element (CE).

Example 12 includes a method of operating a user equipment (UE), the method including: receiving, from a base station, a layer 1 or a layer 2 (L1/L2) message including an indication of a logical channel (LCH); including or excluding the LCH in a logical channel prioritization (LCP) procedure based on the indication of the L1/L2 message; and performing the LCP procedure based on said including or excluding the LCH.

Example 13 includes the method of example 12 or some other examples herein, wherein said receiving an L1/12 message comprises receiving an L1 message with a uplink grant.

Example 14 includes the method of examples 12 or 13 or some other examples herein, wherein said receiving an L1/L2 message includes receiving an L2 message with a configured grant (CG), configured grant is to include an activated CG occasion, and said performing the LCP procedure is to be applied during the activated CG occasion.

Example 15 includes a method of operating a base station (BS), the method including: sending, to a user equipment (UE), a layer 1 or a layer 2 (L1/L2) message including an indication of a logical channel (LCH) for an inclusion or exclusion of the LCH in a logical channel prioritization (LCP) procedure; and receiving, from the UE, an uplink transmission based on the inclusion or exclusion of the of the LCH.

Example 16 includes the method of example 15 or some other examples herein, wherein said sending a L1/L2 message includes sending a L1 message with a uplink grant or the L2 message is a configured grant.

Example 17 includes a method of operating a user equipment (UE), the method including: receiving, from a base station, an indication of a delay threshold; and performing a logical channel prioritization (LCP) procedure based on the delay threshold.

Example 18 includes the method of example 17 or some other examples herein, wherein the delay threshold is associated with a logical channel (LCH).

Example 19 includes the method of examples 17 or 18 or some other examples herein, wherein the LCP procedure includes: computing a delay associated with a logical channel (LCH); selecting the LCH based on the delay being greater than or equal to the delay threshold; and prioritizing the LCH.

Example 20 includes a method of operating a user equipment (UE), the method including: receiving, from a base station, an indication of deprioritizing a transmission of a medium access control (MAC) control element (CE); and performing a logical channel prioritization (LCP) procedure based on the indication.

Example 21 includes the method of example 20 or some other examples herein, wherein the transmission of the MAC CE is associated with a dynamic grant or a configured grant.

Example 22 includes the method of examples 20 or 21 or some other examples herein, wherein the indication is included in a radio resource control (RRC) message, a MAC message, or a downlink control information message.

Example 23 includes a method of operating a user equipment (UE), the method including: receiving, from a base station, a configuration; assigning, to a logical channel (LCH), a state based on the configuration and a status of buffered data; and performing a logical channel prioritization (LCP) procedure for the LCH based on the state.

Example 24 includes the method of example 23 or some other examples herein, wherein the LCP procedure includes: selecting a logical channel (LCH) based on the state; and prioritizing the LCH based on a configured LCH priority or the state.

Another example may include an apparatus comprising logic, modules, or circuitry to perform one or more elements of a method described in or related to any of examples 1-24, or any other method or process described herein.

Another example may include a method, technique, or process as described in or related to any of examples 1-24, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-24, or portions thereof.

Another example includes a signal as described in or related to any of examples 1-24, or portions or parts thereof.

Another example may include a datagram, information element, packet, frame, segment, PDU, or message as described in or related to any of examples 1-24, or portions or parts thereof, or otherwise described in the present disclosure.

Another example may include a signal encoded with data as described in or related to any of examples 1-24, or portions or parts thereof, or otherwise described in the present disclosure.

Another example may include a signal encoded with a datagram, IE, packet, frame, segment, PDU, or message as described in or related to any of examples 1-24, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-24, or portions thereof.

Another example may include a computer program comprising instructions, wherein execution of the program by a processing element is to cause the processing element to carry out the method, techniques, or process as described in or related to any of examples 1-24, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-24. (canceled)

25. A method comprising:
receiving, from a network, a logical channel prioritization (LCP) configuration;
receiving, from the network, a layer 1 (L1) or layer 2 (L2) message including an indication to activate the LCP configuration; and
performing an LCP procedure based on the LCP configuration.

26. The method of claim 25, wherein the LCP configuration is included in a radio resource control (RRC) message.

27. The method of claim 25, wherein the LCP configuration is included in the L1 or L2 message.

28. The method of claim 25, wherein said receiving an L1 or L2 message comprises receiving an L1 message with an uplink grant or an L2 message with a medium access control (MAC) control element (CE).

29. The method of claim 25, wherein the LCP configuration is associated with a logical channel (LCH) that includes an urgent flag.

30. The method of claim 29, wherein the L1 or L2 message includes an urgent level associated with the urgent flag of the LCH.

31. The method of claim 29, wherein the LCP procedure is an urgent LCP procedure based on the L1 or L2 message or based on a condition detected by the UE, and wherein the urgent LCP procedure includes:
determining a set of LCHs based on the urgent flag or the LCP configuration; and
prioritizing at least one LCH of the set of LCHs.

32. The method of claim 25, wherein the LCP configuration includes a delay threshold associated with a logical channel (LCH), and wherein to perform the LCP procedure includes to:
compute a delay associated with a logical channel (LCH);
prioritize the LCH based on the delay being greater than the delay threshold.

33. The method of claim 25, wherein the LCP configuration includes an indication to deprioritize a transmission of a medium access control (MAC) control element (CE).

34. The method of claim 33, wherein the MAC CE is associated with a dynamic grant or a configured grant.

35. The method of claim 25, further comprising:
assigning, to a logical channel (LCH), a state based on the LCP configuration and a status of buffered data in the LCH; and
performing the LCP procedure for the LCH based on the state.

36. A method comprising:
generating, for transmission to a user equipment (UE), a logical channel prioritization (LCP) configuration;
generating, for transmission to the UE, a layer 1 (L1) or layer 2 (L2) message including an indication to activate the LCP configuration; and
receiving, from the UE, an uplink transmission based on the LCP configuration.

37. The method of claim 36, wherein the LCP configuration is included in a radio resource control (RRC) message or the L1 or L2 message.

38. The method of claim 36, wherein said generating an L1 or L2 message comprises generating an L1 message with an uplink grant or an L2 message with a medium access control (MAC) control element (CE).

39. The method of claim 36, wherein the LCP configuration is associated with a logical channel (LCH) that includes an urgent flag.

40. The method of claim 36, wherein the LCP configuration includes a delay threshold associated with a logical channel (LCH) to indicate that the UE is to prioritize the LCH based on a delay being greater than the delay threshold.

41. The method of claim 36, wherein the LCP configuration includes an indication to deprioritize a transmission of a medium access control (MAC) control element (CE).

42. An apparatus comprising:
processor circuitry to:
receive, from a network, a layer 1 (L1) or layer 2 (L2) message including an indication of a logical channel (LCH);
determine to include or exclude the LCH in a logical channel prioritization (LCP) procedure based on the indication of the LCH; and
perform the LCP procedure based on said determination to include or exclude the LCH; and
interface circuitry coupled to the processor circuitry to enable communication.

43. The apparatus of claim 42, wherein the L1 or L2 message includes an L1 message with an uplink grant.

44. The apparatus of claim 42, wherein the L1 or L2 message includes an L2 message with a configured grant (CG), wherein the configured grant is to include an activated CG occasion, and wherein the LCP procedure is to be applied during the activated CG occasion.
